(19) United States
(12) Patent Application Publication
(10) Pub. No.: US 2019/0096604 A1
(43) Pub. Date: Mar. 28, 2019

(54) KEYPAD MODULE

(71) Applicants: LITE-ON ELECTRONICS (GUANGZHOU) LIMITED, GUANGZHOU (CN); Lite-On Technology Corporation, Taipei (TW)

(72) Inventor: Ming-Fu Yen, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/871,026

(22) Filed: Jan. 14, 2018

(30) Foreign Application Priority Data
Sep. 25, 2017 (CN) 201710872291.7

(51) Int. Cl. H01H 13/705; H01H 3/12; H01H 13/14

(52) U.S. Cl. CPC H01H 13/705; H01H 13/14; H01H 3/125

(57) ABSTRACT

The invention provides a keypad module, including a bottom plate, a circuit film, an elastic element, a scissor structure, a keycap and a buffering material layer. The circuit film is disposed on the bottom plate and includes a switch. The elastic element is disposed on the switch. The scissor structure is fixed on the bottom plate. The keycap is disposed on the scissor structure. The buffering material layer is disposed on the inner surface of the keycap.

### CROSS REFERENCE TO RELATED APPLICATION

This application claims the priority benefit of China application serial no. 201710872291.7, filed on Sep. 25, 2017. The entirety of the above-mentioned patent application is hereby incorporated by reference herein and made a part of specification.

### BACKGROUND OF THE INVENTION

### Field of the Invention

The invention is related to a keypad module, and particularly to a keypad module that is capable of reducing noises.

### Description of Related Art

Conventional notebook computers are generally provided with a keypad which allows users to have concrete sense of touch during typing. However, since the keypad is a mechanical assembly that is assembled with a plurality of elements, when each key is pressed, minor noises are easily generated when the internal elements collide with each other. It is an important issue for persons skilled in the art to find out how to eliminate or reduce the noises caused by the internal elements when they collide with each other while the keys are pressed.

### SUMMARY OF THE INVENTION

The invention provides a keypad module which is capable of reducing noises generated when the keys are pressed.

In the invention, the keypad module includes a bottom plate, a circuit film, an elastic element, a scissor structure, a keycap and a buffering material layer. The circuit film is disposed on the bottom plate and includes a switch. The elastic element is disposed on the switch. The scissor structure is fixed on the bottom plate. The keycap is disposed on the scissor structure. The buffering material layer is disposed on an inner surface of the keycap.

In an embodiment of the invention, the hardness of the buffering material layer is smaller than the hardness of the keycap and the hardness of the scissor structure.

In an embodiment of the invention, the thickness of the buffering material layer ranges from 0.03 mm to 0.3 mm.

In an embodiment of the invention, the material of the keycap includes a metal or a plastic.

In an embodiment of the invention, the material of the buffering material layer includes a photocurable resin.

In an embodiment of the invention, the buffering material layer is coated and externally attached to the inner surface of the keycap.

In an embodiment of the invention, the material of the keycap includes plastic; the material of the buffering material layer includes a sponge or a rubber. The buffering material layer is formed on the inner surface of the keycap by double injection molding.

In an embodiment of the invention, the material of the buffering material layer includes a sponge, a rubber or a silicon; the buffering material layer is attached to the inner surface of the keycap.

In an embodiment of the invention, the keypad module further includes a balance rod disposed between the bottom plate and the keycap, wherein a projection of the balance rod with respect to the inner surface of the keycap is within a range of the buffering material layer on the inner surface.

In an embodiment of the invention, the keypad module is a long key on a notebook computer.

In summary, the invention provides a keypad module which has the buffering material layer that is disposed between the scissor structure and the keycap such that the buffering material layer can reduce the noises generated when the inner structures collide with each other when the keycap is pressed.

In order to make the aforementioned features and advantages of the disclosure more comprehensible, embodiments accompanying figures are described in detail below.

### BRIEF DESCRIPTION OF THE DRAWINGS

FIG. 1 is a schematic view illustrating a keypad module according to an embodiment of the invention.

FIG. 2 is a schematic explosive view of the keypad module in FIG. 1.

FIG. 3 is a schematic view illustrating another angle of the keypad module in FIG. 2.

FIG. 4 is a schematic explosive view illustrating a scissor structure of the keypad module in FIG. 1.

FIG. 5 is a schematic view of a keypad module according to another embodiment of the invention.

### DESCRIPTION OF EMBODIMENTS

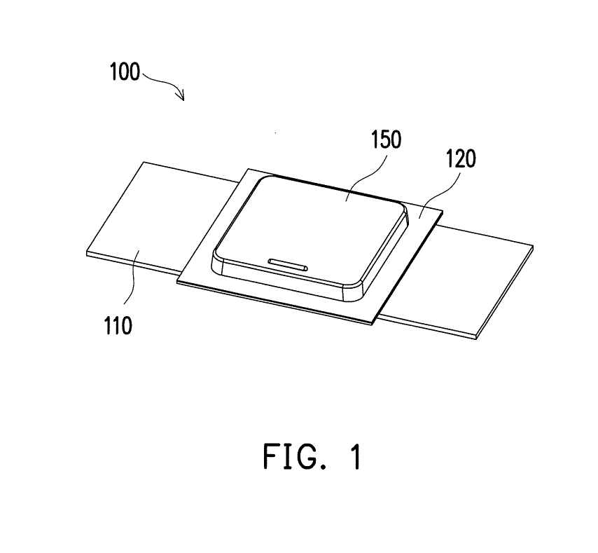

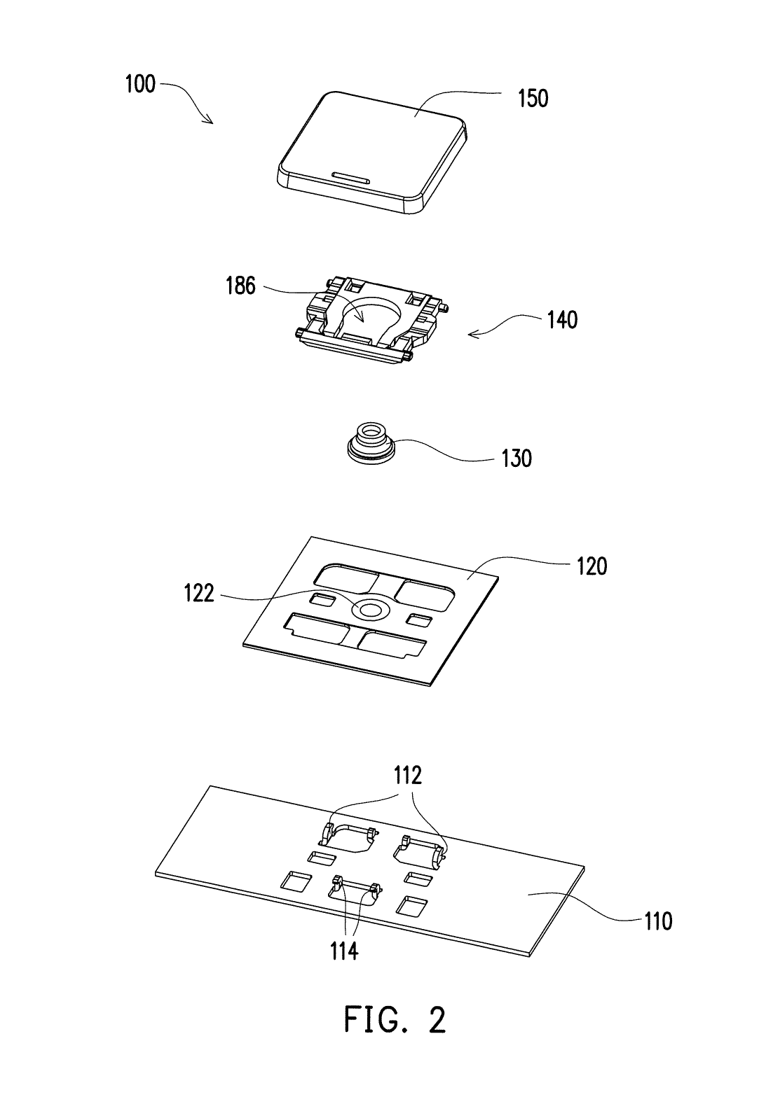

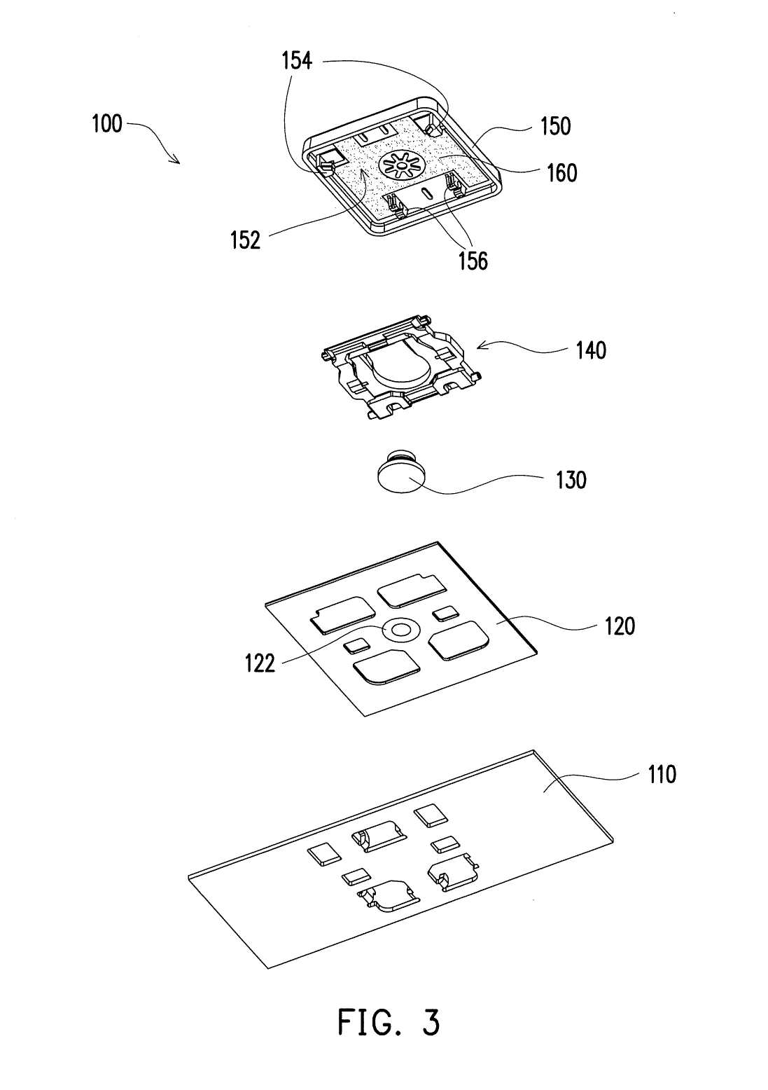

FIG. 1 is a schematic view illustrating a keypad module according to an embodiment of the invention. FIG. 2 is a schematic explosive view of the keypad module in FIG. 1. FIG. 3 is a schematic view illustrating another angle of the keypad module in FIG. 2. Referring to FIG. 1 to FIG. 3, a keypad module 100 includes a bottom plate 110, a circuit film 120, an elastic element 130, a scissor structure 140, a keycap 150 and a buffering material layer 160. In the embodiment, the keypad module 100 is exemplified as a single key on a notebook computer. In other embodiments, the keypad module may be a long key on the notebook computer.

Specifically, the circuit film 120 is disposed on the bottom plate 110 and includes a switch 122; the elastic element 130 is disposed on the switch 122. The scissor structure 140 is fixed on the bottom plate 110; the keycap 150 is disposed on the scissor structure 140; the buffering material layer 160 (shown in FIG. 3) is disposed on an inner surface 152 of the keycap 150; the elastic element 130 is located in a through slot 186 of the scissor structure 140. In other words, the circuit film 120 is located between the scissor structure 140 and the bottom plate 110; the scissor structure 140 is located between the circuit film 120 and the keycap 150; and the buffering material layer 160 is located between the scissor structure 140 and the keycap 150.

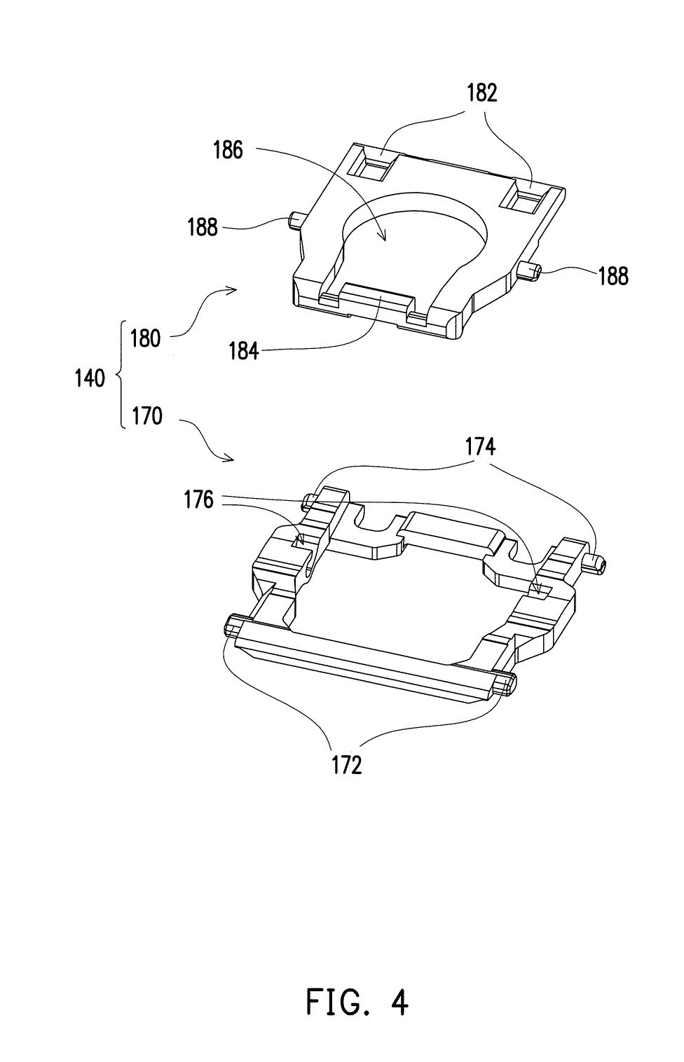

FIG. 4 is a schematic explosive view illustrating a scissor structure of the keypad module in FIG. 1. Referring to FIG. 1 to FIG. 4, specifically, the scissor structure 140 includes a first supporting frame 170 and a second supporting frame 180 pivoted to each other. The first supporting frame 170 has an opening 176 and the second supporting frame 180 has a pivot shaft 188. The pivot shaft 188 of the second supporting frame 180 is pivoted to the opening 176 of the first supporting frame 170 such that the second supporting frame 180 is movably pivoted on the first supporting frame 170. On the other hand, two opposite sides of the first supporting frame 170 are respectively connected to the bottom plate 110 and the keycap 150; two opposite sides of the second supporting frame 180 are respectively connected to the bottom plate 110 and the keycap 150, and the two respective sides of the first supporting frame 170 and the second supporting frame 180 are movably pivoted on the bottom plate 110 and the keycap 150. Specifically, a first connecting portion 172 of the first supporting frame 170 is connected to a first keycap connecting portion 154 of the keycap 150, and a second connecting portion 174 on another side of the first supporting frame 170 is connected to a first bottom plate connecting portion 112 of the bottom plate 110. A third connecting portion 182 of the second supporting frame 180 is connected to a second keycap connecting portion 156 of the keycap 150. A fourth connecting portion 184 on another side of the second supporting frame 180 is connected to a second bottom plate connecting portion 114 of the bottom plate 110.

In the embodiment, the buffering material layer 160 corresponds to a portion of the scissor structure 140. Specifically, the buffering material layer 160 corresponds to the inner surface 152 that is outside the position where the keycap 150 and the scissor structure 140 are pivoted together. Therefore, when the keycap 150 is pressed, the buffering material layer 160 may be used to reduce the noise that is caused by the collision of the portion outside the position where the scissor structure 140 and the keycap 150 are pivoted together. For example, the proportion of the area occupied by the buffering material layer 160 on the inner surface 152 may be 65% to 85%, but the proportion of the area occupied by the buffering material layer 160 on the inner surface 152 is not limited thereto. In other embodiment, the buffering material layer may be disposed only at a position where the keycap collides with the scissor structure; in this manner, the consumption of the material for the buffering material layer can be reduced so as to save cost.

In the embodiment, the material of the keycap 150 includes metal or plastic. The material of the buffering material layer 160 includes a sponge, a rubber, a silicon or a photocurable resin; however, the invention provides no particular limitation to the material of the buffering material layer 160 and the keycap 150 as long as the hardness of the buffering material layer 160 is smaller than the hardness of the keycap 150, and the hardness of the buffering material layer 160 is smaller than the hardness of the scissor structure 140. Preferably, the thickness of the buffering material layer 160 ranges from 0.03 mm to 0.3 mm; more preferably, the thickness of the buffering material layer 160 ranges from 0.03 mm to 0.1 mm, and the thickness of the buffering material layer 160 may be determined depending on the hardness thereof. For example, when the buffering material layer 160 having softer hardness is used, the buffering material layer 160 with thicker thickness may be used. On the other hand, when the buffering material layer 160 having harder hardness is used, the buffering material layer 160 with thinner thickness may be used.

In the embodiment, the buffering material layer 160 may be attached to the inner surface 152 of the keycap 150 via a gel. Specifically, the material of the keycap 150 may be a metal or a plastic. The material of the buffering material layer 160 may be a sponge, a rubber or a silicon. A layer of gel may be disposed on the inner surface 152 of the keycap 150 first, then the sponge, the rubber or the silicon is attached on the inner surface 152 of the keycap 150 via the gel; the processing operation is simple and easy to perform.

In addition, the buffering material layer 160 may be formed on the inner surface 152 of the keycap 150 in one time by double injection molding. Specifically, the material of the keycap 150 may be a plastic, and the material of the buffering material layer 160 may be a sponge or a rubber. In the processing operation, the plastic may be formed into the keycap 150 via injection molding; thereafter, the sponge or the rubber may be subsequently formed on the inner surface 152 of the keycap 150. The processing operation can be simplified by using the double injection molding. Workers can form the buffering material layer 160 on the inner surface 152 of the keycap 150 in one time simply by providing the material for the keycap 150 and the buffering material layer 160.

Moreover, the buffering material layer 160 may be externally attached to the inner surface 152 of the keycap 150 via coating. Specifically, the material of the keycap 150 may be a metal or a plastic, and the material of the buffering material layer 160 may be a photocurable resin. After the photocurable resin is attached to the inner surface 152 of the keycap 150 via coating, a UV-light irradiating process may be used to further improve the hardness of the photocurable resin. In order to ensure that the photocurable resin can provide a buffering function, the hardness of the photocurable resin is still smaller than the hardness of the keycap 150, and the hardness of the buffering material layer 160 is still smaller than the hardness of the scissor structure 140; therefore, the invention provides no particular limitation to the hardness of the buffering material layer 160. Furthermore, as described above, the degree that the buffering material layer 160 is hardened via the UV-light irradiating process may be determined according to the thickness of the buffering material layer 160. In other words, when the thickness of the buffering material layer 160 is thicker, the time of performing the UV-light irritating process may be shortened so that the hardness of the buffering material layer 160 is softer. On the other hand, when the thickness of the buffering material layer 160 is thinner, the time of performing the UV-light irritating process may be increased so that the hardness of the buffering material layer 160 is greater. Therefore, when using the photocurable resin as the buffering material layer 160 on the inner surface 152 of the keycap 150, in addition to that the coating and the UV-light irradiating processes are simple for performing processing, there is no need to determine the hardness of the buffering material layer 160 in advance. Instead, the hardness of the buffering material layer 160 can be changed freely by adjusting the time of performing UV-light irradiating process depending on the thickness of the buffering material layer 160 that is actually coated on the inner surface 152. In other words, when the material of the buffering material layer 160 is the photocurable resin, the workers on site can change the hardness of the buffering material layer 160 freely according to the actual thickness of the buffering material layer 160 that is acquired after the processing operation so as to better satisfy the actual needs.

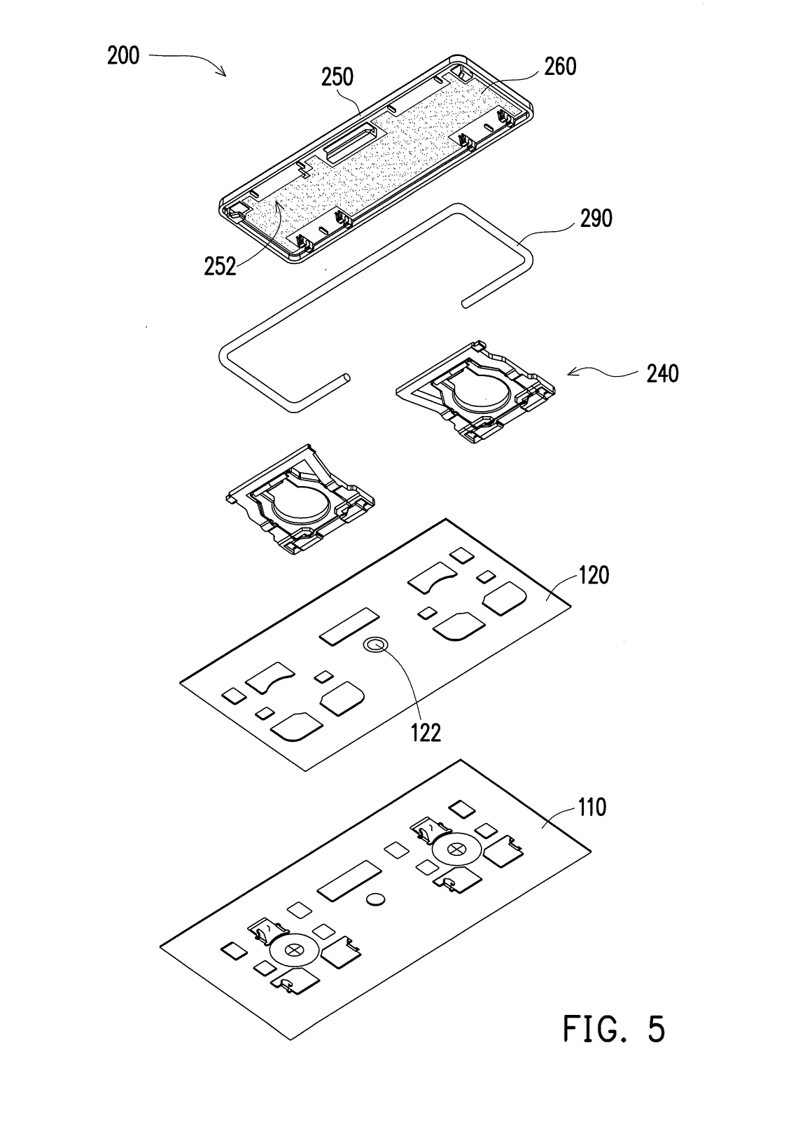

FIG. 5 is a schematic view of a keypad module according to another embodiment of the invention. FIG. 5 schematically illustrates that a balance rod 290 is located between a keycap 250 and a scissor structure 240. In a keypad module 200 of the embodiment, the reference numerals that are the same as or similar to those used for the keypad module 100 in the previous embodiments are used. The embodiment only describes the differences between the keypad module 100 and the keypad module 200. Referring to FIG. 5, in the embodiment, the keypad module 200 is a long key on a notebook computer. The keypad module 200 further includes the balance rod 290 disposed between the bottom plate 110 and the keycap 250 as well as between the scissor structure 240 and the keycap 250. A balance rod is disposed for the long key on conventional notebook computers so that the whole key can be pressed down completely no matter which part of the key is pressed. At this time, a plurality of movable elements such as the scissor structure 240 and the balance rod 290 are disposed between the bottom plate 110 and the keycap 250. Therefore, when being pressed down, the keycap 250 is easily to collide with the scissor structure 240 and the balance rod 290 and causes noise, and the balance rod 290 may be a metal material, which causes louder noise when the elements collide with each other. Therefore, a buffering material layer 260 is disposed on an inner surface 252 of the keycap 250, and the configuration area thereof corresponds to the scissor structure 240 and the balance rod 290, which helps to reduce the noise caused by the keycap 250 as well as the scissor structure 240 and the balance rod 290 when they collide with each other, wherein a projection of the balance rod 290 with respect to the inner surface 252 of the keycap 250 is in the range of the buffering material layer 260 on the inner surface 252. In the words, apart from the previous embodiment, the configuration area of the buffering material layer 260 further corresponds to the balance rod 290 so as to ensure that the buffering material layer 260 is in contact with the balance rod 290. In other words, when the keycap 250 is pressed, the balance rod 290 can be in contact with the buffering material layer 260 first, and with the shock-absorbing function provided by the buffering material layer 260, the sound caused by the keycap 250 and the balance rod 290 when they collide with each other can be reduced.

In summary, in the keypad module of the invention, the buffering material layer is disposed between the bottom plate and the keycap so that the buffering material layer can be in contact with the scissor structure first when the keycap is pressed; accordingly, the scissor structure absorbs shock via the buffering material layer, thereby reducing the sound caused by the keycap and the scissor structure when they collide with each other and the noise can be thus reduced. Furthermore, when the keypad module is the long key on a notebook computer, the buffering material layer located between the keycap and the balance rod may be used to reduce the sound caused by the keycap and the balance rod when they collide with each other, thereby reducing noise. Furthermore, the buffering material layer of the invention may be disposed on the inner surface of the keycap via a plurality of processing operations. When the buffering material layer is attached to the inner surface of the keycap via a gel, the processing operation is simple and easy to perform. When the buffering material layer is formed on the inner surface of the keycap in one time via double injection molding, the processing operation may be further simplified so that the workers can form the buffering material layer on the inner surface of the keycap in one time by simply providing the material for the keycap and the buffering material layer. When the buffering material layer is externally attached to the inner surface of the keycap via coating, the workers on site can change the hardness of the buffering material layer freely according to the actual thickness of the photocurable resin that is acquired after the processing operation so as to better satisfy the actual needs.

Although the invention has been disclosed by the above embodiments, the embodiments are not intended to limit the invention. It will be apparent to those skilled in the art that various modifications and variations can be made to the structure of the invention without departing from the scope or spirit of the invention. Therefore, the protecting range of the invention falls in the appended claims.

1. A keypad module, comprising:
a bottom plate;
a circuit film, disposed on the bottom plate and comprising a switch;
an elastic element, disposed on the switch;
a scissor structure, fixed on the bottom plate;
a keycap, disposed on the scissor structure; and
a buffering material layer, disposed on an inner surface of the keycap,
wherein an area of the buffering material layer is smaller than an area of the inner surface of the key cap.

2. The keypad module according to claim 1, wherein a hardness of the buffering material layer is smaller than a hardness of the keycap and a hardness of the scissor structure.

3. The keypad module according to claim 1, wherein a thickness of the buffering material layer ranges from 0.03 mm to 0.3 mm.

4. The keypad module according to claim 1, wherein a material of the keycap comprises a metal or a plastic.

5. The keypad module according to claim 4, wherein a material of the buffering material layer comprises a photocurable resin.

6. The keypad module according to claim 5, wherein the buffering material layer is externally attached to the inner surface of the keycap via coating.

7. The keypad module according to claim 4, wherein a material of the keycap comprises a plastic, a material of the buffering material layer comprises a sponge or a rubber, the buffering material layer is formed on the inner surface of the keycap via double injection molding.

8. The keypad module according to claim 4, wherein a material of the buffering material layer comprises a sponge, a rubber or a silicon, and the buffering material layer is attached to the inner surface of the keycap.

9. The keypad module according to claim 1, further comprising:
a balance rod, disposed between the bottom plate and the keycap.

10. The keypad module according to claim 8, wherein the keypad module is a long key of a notebook computer.
